(19) United States
(12) Patent Application Publication
(10) Pub. No.: US 2009/0151439 A1
(43) Pub. Date: Jun. 18, 2009

(54) METHOD AND DEVICE FOR DETERMINING THE CONDITION OF AT LEAST ONE TYRE OF A VEHICLE WHEEL

(75) Inventors: Denis Le Bret, Chaville (FR); Zahir Djama, Paris (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 12/067,173

(22) PCT Filed: Sep. 11, 2006
(86) PCT No.: PCT/FR06/50867

§ 371 Date: Aug. 29, 2008

(30) Foreign Application Priority Data
Sep. 16, 2005 (FR) 0509505

(51) Int. Cl. G01M 17/02

(52) U.S. Cl. 73/146

(57) ABSTRACT

The invention concerns a method for diagnosing the condition of at least one tire of a vehicle wheel connected to the body shell thereof via a suspension, including, for the or each tire, a step (102) of acquiring the vertical acceleration of the wheel in a reference model of the vehicle. Said method includes a step (108) of filtering the acquired acceleration to eliminate the frequencies thereof lower than a predetermined filtering frequency, a step (110) of determining a vertical excitation applied to the tire based on the filtered acceleration, and a step (112, 114, 116, 118, 120) of determining the condition of the tire based on the determined excitation.

The present invention concerns a method of diagnosing the state of at least one tire of a vehicle wheel connected to the body thereof by means of a suspension, of the type comprising, for the or each tire, a step of acquiring the vertical acceleration of the wheel in a referential of the vehicle.

The present invention also concerns a diagnostic system implementing such a method.

Methods exist that use the measurement of the rotation speed of a motor vehicle wheel to diagnose the state of the tire of this wheel, and in particular its under-inflated state. However, an under-inflated state, if it is not quickly corrected, triggers an irreversible alteration of the dynamic behavior of the tire, even once it has been inflated again, and methods of the state of the art do not make it possible to diagnose this alteration.

The objective of the present invention is to remedy the above-mentioned problem by proposing a method and a system capable of diagnosing anomalies of a tire, such as an unbalance or a hernia, and this, even if the tire is inflated in an appropriate manner.

To this effect, an object of the invention is a method of diagnosing the state of at least one tire of a vehicle wheel connected to the body thereof by means of a suspension, of the type comprising, for the or each tire, a step of acquiring the vertical acceleration of the wheel in a referential of the vehicle, characterized in that it comprises:
a step of filtering the acquired acceleration to eliminate the frequencies thereof lower than a predetermined filtering frequency;
a step of determining a vertical excitation applied to the tire as a function of the filtered acceleration; and
a step of determining the state of the tire as a function of the determined excitation.

According to particular embodiments, the method can include one or more of the following characteristics:
the filtering frequency is higher than the range of rolling resistance frequencies of the wheel;
the filtering frequency is higher than 25 Hz;
the filtering step is a step of high-pass filtering;
the step of determining the vertical excitation applied to the tire comprises a step of calculating this vertical excitation from a inverse model of a mono-wheel mechanical model of the wheel connected to the body of the vehicle by means of the suspension;
the step of determining the state of the tire comprises a step of comparing the determined excitation to a predetermined threshold value and a step of diagnosing the state of the tire adapted to determine that this tire has an anomaly if the determined excitation is higher than the threshold value at least once;
the threshold value is substantially equal to 1 millimeter;
the method further comprises a step of acquiring the speed of the vehicle and a supervising step adapted to trigger the diagnostic of the tire state or validate the determined state of the tire if at least the speed of the vehicle is higher than a predetermined threshold speed; and
the threshold speed is substantially equal to 50 km/h.

Another object of the invention is a system for diagnosing the state of at least one tire of a vehicle wheel connected to the body thereof by means of a suspension, of the type comprising, for the or each tire, means for acquiring the vertical acceleration of the wheel in a referential of the vehicle, characterized in that it is adapted to implement a method of the above-mentioned type.

The invention will be better understood by reading the following description given by way of example only in reference to the annexed drawings, in which:

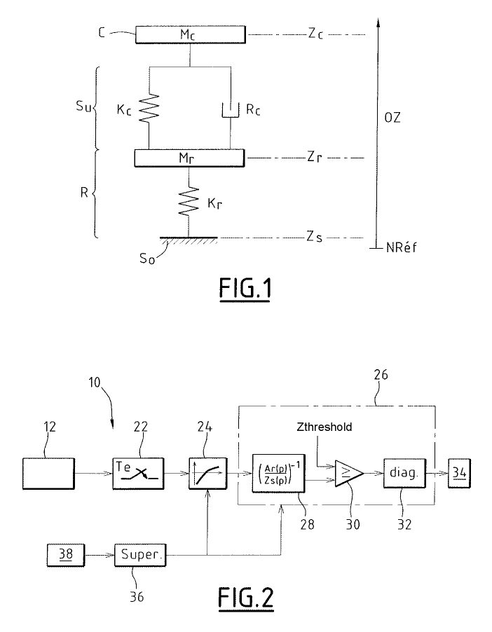

FIG. 1 is a mechanical model of a motor vehicle wheel connected to the body thereof by a suspension;

FIG. 2 is a schematic view of a system according to the invention; and

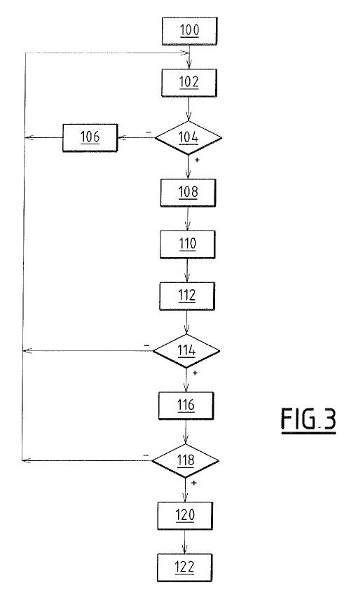

FIG. 3 is a flow chart of the method implemented by the system of FIG. 2.

FIG. 1 illustrates a mono-wheel mechanical model of a wheel R of a four-wheel motor vehicle, connected to the body C thereof by means of a suspension Su, the wheel R being in contact with the ground So.

The body C is modelized by a mass M_{c} adjusted to the wheel, occupying, on a vertical axis OZ of the vehicle, an altitude Z_{c} with respect to a reference level NRef, for example, the altitude of the ground So when the vehicle is starting off.

The suspension Su is modelized by a spring having a coefficient of stiffness K_{c} in parallel with a damper having a damping coefficient R_{c}. The wheel R is modelized by a mass Mᵣ, occupying on the axis OZ an altitude Zᵣ with respect to the reference level Nref. The tire thereof is modelized by a spring having a coefficient of stiffness Kᵣ in contact with the ground So, occupying on the axis OZ an altitude Zₛ with respect to the reference level Nref.

When the vehicle is moving, the behavior of this mechanical system is controlled by the evolution with time of the altitude Zₛ of the ground.

Using the fundamental principle of dynamics, it can be shown that the mono-wheel mechanical model of FIG. 1 satisfies the following equations:

$$\frac{{A}_{r} ( p )}{{Z}_{s} ( p )} = H ( p ) = \frac{{K}_{r} {p}^{2} ( {M}_{c} {p}^{2} + {R}_{c} p + {K}_{c} )}{L ( p )} \\ L ( p ) = {M}_{r} {M}_{c} {p}^{4} + {R}_{c} ( {M}_{c} + {M}_{r} ) {p}^{3} + ( {M}_{r} {K}_{c} + {M}_{c} ( {K}_{r} + {K}_{c} ) ) {p}^{2} + {R}_{c} {K}_{r} p + {K}_{c} {K}_{r} \qquad ( 1 )$$

where p is the Laplace variable and Aᵣ is the vertical acceleration along the axis OZ of the center of the wheel R.

It can be shown that the model according to the equations (1) is invertible.

In reference to FIG. 2, a system according to the invention for diagnosing the state of a tire of a motor vehicle wheel connected to the body thereof by means of a suspension will now be described. This system is based on the mono-wheel model according to equations (1) and more particularly on a discretization of these equations.

This system is designated by the general reference 10 and includes a mono-axis accelerometer 12 arranged in the area of the center of the wheel and measuring the vertical acceleration Aᵣ thereof according to the axis OZ.

The accelerometer 12 is adapted to supply, via a wire connection 14, a signal representative of the vertical acceleration to means 20 provided to extract the vertical acceleration Ar from this signal.

The means 20 are connected to an analogic/digital converter 22, for example, a zero order blocker sampler adapted to digitalize the measured acceleration Aᵣ with a predetermined sampling period Te, for example, comprised between about 0.001 seconds and 0.02 seconds, and thus to supply as output a digital acceleration Aᵣ(k) of the wheel, where k represents the k^{th} sampling instant.

The analogic/digital converter 22 is connected to a filter 24. This filter 24 is adapted to process the digital acceleration Aᵣ(k) of the wheel by applying to it a high-pass filtering of the frequencies higher than a predetermined filtering frequency f_{c}.

This frequency f_{c} is higher than the range of rolling resistance frequencies of the wheel in which the power of the modes of the wheel are essentially concentrated. In a typical manner, this range is substantially equal to [8; 20] Hz and in a preferred embodiment of the invention, the frequency f_{c} is substantially equal to 25 Hz. Thus, the frequencies lower than f_{c} of the digital acceleration Aᵣ(k) are substantially eliminated by the filter 24.

Further, the high-pass filter 24 is connected to a unit 26 adapted to implement a diagnostic of the state of the tire as a function of the filtered digital acceleration A_{rf}(k).

This unit 26 comprises a computing module 28 adapted to reconstruct a digital excitation Zₛ(k) applied to the tire by the ground from a model inverse from that of the equations (1) as a function of the filtered digital acceleration A_{rf}(k). The reconstruction of such an excitation by the module 28 is performed, for example, from a bilinear discretization of the model H⁻¹(p) with a sampling period Te, which is possible due to the invertible property of the model H(p).

The diagnostic unit 26 also comprises a comparison module 30 connected to the computing module 28 and adapted to compare the reconstructed digital excitation Zₛ(k) to a predetermined threshold value Zthreshold, for example, substantially equal to 1 millimeter.

The unit 26 also comprises a diagnostic module 32 connected to the comparison module 30 and adapted to diagnose that the state of the tire is defective if the reconstructed excitation Zₛ(k) has a least N values higher than the threshold values Zthreshold, where N is a predetermined integral number, for example, equal to 100.

The unit 26 is connected to an alarm system 34 housed in the passenger compartment of the vehicle and adapted to supply a visual and/or sound signal if the state of the tire is diagnosed as defective.

Finally, the system 10 according to the invention comprises a supervision module 36 connected to a sensor 38 of the speed of the vehicle to receive a measurement of the speed thereof. The supervision module 36 is adapted to activate the high-pass filter 24 and the computing unit 26 when the measured speed of the vehicle is higher than a predetermined speed substantially equal to 50 km/h. Indeed, it can be shown that the precision of the diagnostic performed by the system according to the invention is increased for speeds of the vehicle higher than 50 km/h.

FIG. 3 is a flow chart of the diagnostic method implemented by the system of FIG. 2.

In a first initialization step 100, for example, activated following the setting in motion of the vehicle, a counter of anomalies is initialized to zero.

A subsequent acquisition step 102 consists in measuring the vertical acceleration Aᵣ of the wheel and the speed V of the vehicle and in digitalizing these measurements according to the sampling period Te.

Then, a first test is performed at 104 to know whether the speed of the vehicle acquired at 102 is higher than a predetermined threshold, for example, 50 km/h. If the result of this test is negative, the counter of anomalies is reinitialized to zero in a step 106. The step 106 then loops back to the acquisition step 102.

If the result of the test in 104 is positive, a high-pass filtering is applied at 108 to the digitalized vertical acceleration Aᵣ(k) to substantially eliminate the frequencies thereof lower than the frequency f_{c}.

Then, in a calculation step 110, the digital excitation Zₛ(k) applied to the tire by the ground is calculated as a function of the filtered digital acceleration A_{rf}(k) from the discretization of the model H⁻¹(p).

In a following step 112, the excitation Zₛ(k) is compared to the threshold value Z_{threshold} of 1 millimeter. Then, at 114, a second test is implemented to know whether the excitation Zₛ(k) has values higher than 1 mm.

If the result of this test is negative, the step 114 loops back to acquisition step 102. Otherwise, the counter of anomalies is incremented at 116 by the number of values of the excitation Zₛ(k) higher than 1 millimeter.

A third test is then performed at 118 to determine whether the value of the counter of anomalies is higher than N. If the result of this test is negative, the step 118 then loops back to step 102. Otherwise, the state of the tire is diagnosed as defective at 120. A sound and/or visual alarm in the passenger compartment of the vehicle is then triggered at 122 to warn the driver of this diagnostic.

The system and the method according to the invention thus make is possible to diagnose anomalies of the tire, and in particular an unbalance or a hernia thereof, in an efficient manner and this, even if the tire is inflated in an appropriate manner. Indeed, it is observed that the frequency of the component of the vertical acceleration of the wheel linked to the adherence of the tire to the ground and to the characteristics of the envelope of the tire is located beyond the range of rolling resistance of the wheel. However, beyond this frequency range, the actual excitations of the ground on the tire are lower than a value in the order of the millimeter. Thus, for a healthy tire showing no anomalies, no important vertical acceleration of the wheel can be generated beyond the range of rolling resistance.

Also, if the reconstructed excitation has values higher than the threshold value Zthreshold, then this means that the tire has anomalies.

Although the diagnostic of the state of a tire of a motor vehicle wheel has been described, the method and system according to the invention can be applied to other types of vehicle, for example, a motorcycle or a multi-axle vehicle.

Similarly, although a high-pass filtering to eliminate the frequencies of the vertical acceleration of the wheel lower than a predetermined frequency has been described, as a variant, a band-pass filtering is used to filter the noise in the high frequencies also, for example, beyond 100 Hz.

Similarly, although a supervision that activates the diagnostic of the state of the tire for speeds of the vehicle higher than 50 km/h has been described, as a variant, the diagnostic is activated continuously and the supervision consists in validating the results of the diagnostic for speeds of the vehicle higher than 50 km/h.

Similarly, although a method and a system applied to a single tire have been described, as a variant, these method and system apply to any number of tires of the vehicle.

Finally, although a tire excited by the ground when the vehicle is moving has been described, it will be understood that the present invention also applies when the vehicle is placed on a running bench.

1. Method of diagnosing the state of at least one tire of a vehicle wheel connected to the body thereof by means of a suspension, of the type comprising, for the or each tire, a step of acquiring the vertical acceleration of the wheel in a referential of the vehicle, said method comprising:
a step of filtering the acquired acceleration to eliminate the frequencies thereof lower than a predetermined filtering frequency;
a step of determining a vertical excitation applied to the tire as a function of the filtered acceleration; and
a step of determining the state of the tire as a function of the determined excitation.

2. Method according to claim 1, wherein the filtering frequency is higher than the range of rolling resistance frequencies of the wheel.

3. Method according to claim 2, wherein the filtering frequency is higher than 25 Hz.

4. Method according to claim 1, wherein the filtering step (108) is a step of high-pass filtering.

5. Method according to claim 1, wherein the step (110) of determining the vertical excitation applied to the tire comprises a step of calculating this vertical excitation from a inverse model of a mono-wheel mechanical model of the wheel connected to the body of the vehicle by means of the suspension.

6. Method according to claim 1, wherein the step of determining the state of the tire comprises a step of comparing the determined excitation to a predetermined threshold value and a step of diagnosing the state of the tire adapted to determined that this tire has an anomaly if the determined excitation is higher than the threshold value at least once.

7. Method according to claim 6, wherein the threshold value is substantially equal to 1 millimeter.

8. Method according to claim 1, which further comprises a step of acquiring the speed of the vehicle and a supervising step adapted to trigger the diagnostic of the tire state or validate the determined state of the tire if at least the speed of the vehicle is higher than a predetermined threshold speed.

9. Method according to claim 8, wherein the threshold speed is substantially equal to 50 km/h.

10. System for diagnosing the state of at least one tire of a vehicle wheel connected to the body thereof by means of a suspension, of the type comprising, for the or each tire, means for acquiring the vertical acceleration of the wheel in a referential of the vehicle, wherein said system comprises:
means for filtering the acquired acceleration to eliminate the frequencies thereof lower than a predetermined filtering frequency;
means for determining a vertical excitation applied to the tire as a function of the filtered acceleration; and
means for determining the state of the tire as a function of the determined excitation,
said means being adapted to implement a method according to claim 7.
